(19) United States
(12) Patent Application Publication
(10) Pub. No.: US 2025/0223196 A1
(43) Pub. Date: Jul. 10, 2025

(54) H2S REMOVAL FROM PRODUCED WATER BY PLASMA

(71) Applicant: Saudi Arabian Oil Company, Dhahran (SA)

(72) Inventors: Mohammad Saad AlQahtani, Dhahran (SA); Abdulaziz Y. AlAmmar, Dammam (SA); Ammar Alahmed, Al Khobar (SA)

(21) Appl. No.: 18/404,627

(22) Filed: Jan. 4, 2024

(51) Int. Cl. C02F 1/20; C01B 3/04; C01B 3/50; C01B 17/02; C01B 17/04; C02F 1/44; C02F 1/66; C02F 103/10

(52) U.S. Cl. CPC C02F 1/20; C01B 3/04; C01B 3/506; C01B 17/021; C01B 17/0495; C02F 1/44; C02F 1/66; C01B 2203/0277; C01B 2203/046; C01B 2203/0485; C02F 2103/10

(57) ABSTRACT

A method of treating an aqueous solution, where the method includes separating H₂S from the aqueous solution, generating a gas stream including the H₂S, flowing the gas stream into a plasma reactor, igniting a plasma in the plasma reactor including the gas stream, decomposing the H₂S to generate H₂ and elemental sulfur in the plasma generating a product gas stream including the H₂, and condensing the elemental sulfur from the product gas stream as a liquid.

### TECHNICAL FIELD

This disclosure relates to methods and systems of processing, particularly to plasma-based hydrogen sulfide (H₂S) removal from produced water.

### BACKGROUND

Produced water is a highly saline stream produced as a byproduct during the production of crude oil and natural gas. Produced water contains dissolved gases such as H₂S, suspended solids, hydrocarbons, heavy metals, emulsified and non-soluble organics. Produced water is considered by far the largest volume waste stream in oil and gas industries. Therefore, treating and reusing the produced water is highly desirable from both environmental and operational standpoints.

Membrane desalination is typically used to remove salts from produced water. However, multi-stage pretreatment is needed to protect the membrane and extend its lifetime. The pretreatment required prior to the desalination include H₂S removal, de-oiling, and suspended solids removal among others.

### SUMMARY

An embodiment described herein provides a method of treating an aqueous solution, where the method includes separating H₂S from the aqueous solution, generating a gas stream including the H₂S, flowing the gas stream into a plasma reactor, igniting a plasma in the plasma reactor including the gas stream, decomposing the H₂S to generate H₂ and elemental sulfur in the plasma generating a product gas stream including the H₂, and condensing the elemental sulfur from the product gas stream as a liquid.

An embodiment described herein provides a gas treatment system including an H₂S stripper to separate H₂S from an aqueous solution, where the H₂S stripper includes an inlet to receive the aqueous solution, a first outlet to output a gas stream including the H₂S, and a second outlet to output a residual solution, a first plasma reactor to receive the gas stream, where the first plasma unit is configured to sustain a first plasma of the gas stream in the first plasma reactor, where the H₂S is decomposed in the first plasma generating a product gas stream including H₂, and a condenser connected to and disposed downstream of the first plasma reactor.

An embodiment described herein provides a gas treatment system including an H₂S stripper to separate H₂S from an aqueous solution, where the H₂S stripper includes an inlet to receive the aqueous solution, a first outlet to output a gas stream including the H₂S, and a second outlet to output a residual solution, a first plasma reactor to receive the gas stream, the first plasma reactor configured to sustain a first plasma of the gas stream in the first plasma reactor, where the H₂S is decomposed in the first plasma generating a product gas stream including H₂, a condenser connected to and disposed downstream of the first plasma reactor, and an H₂ separator connected to and disposed downstream of the condenser.

### BRIEF DESCRIPTION OF DRAWINGS

FIG. 1 is a block diagram of a plasma-based system for H₂S decomposition.

FIG. 2 is a block diagram of a condenser connected to a plasma reactor.

FIG. 3 is a block diagram of a plasma-based system for H₂S decomposition including two plasma reactors.

FIG. 4 is a block diagram of an H₂ separator connected to a plasma reactor.

FIG. 5 is a block diagram of an ejector device connected to a plasma reactor.

FIG. 6 is an example of an ejector device.

FIG. 7 is an example process flow diagram of a method of H₂S decomposition.

FIG. 8 is a schematic diagram of H₂S stripping in an Aspen HYSYS® simulation.

FIG. 9 is an experimental result of a plasma-based process for H₂S decomposition.

### DETAILED DESCRIPTION

Embodiments described herein provide methods and systems of plasma-based H₂S decomposition as a part of produced water treatment. A conventional produced water treatment process includes an H₂S stripping step to remove H₂S from the produced water prior to desalination. Generally, the stripped H₂S may be sent directly to a thermal oxidizer, which results in enormous sulfur oxide (SOₓ) emissions causing serious environmental pollutions. Therefore, a novel method of treating H₂S in the produced water with less environmental impact is highly desired. The methods and systems described in this disclosure use plasma for treating the H₂S-containing gas stripped from produced water, where H₂S can be split into dihydrogen (H₂) and elemental sulfur efficiently. Since the plasma-based decomposition does not have to involve oxidation, various embodiments can reduce the SOₓ emissions and make the overall produced water treatment process environmentally friendly. The process can be integrated with various steps to improve the H₂S removal and H₂ recovery. For example, the methods can include a step of condensing the elemental sulfur after the H₂S decomposition. Further, the process may be coupled with a second plasma reactor to treat residual H₂S after the first plasma reactor, or an H₂ separator.

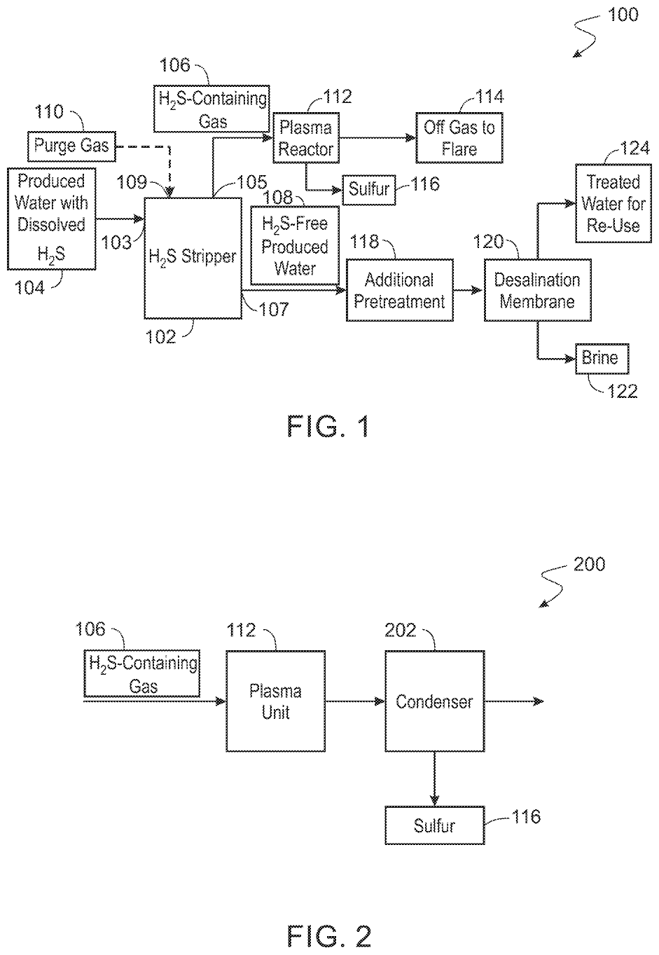

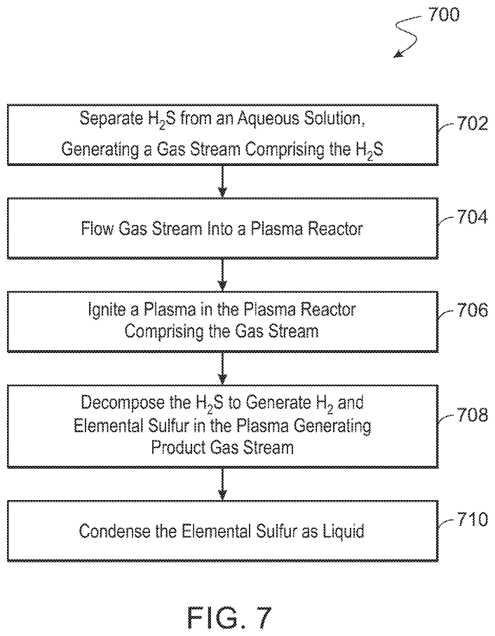

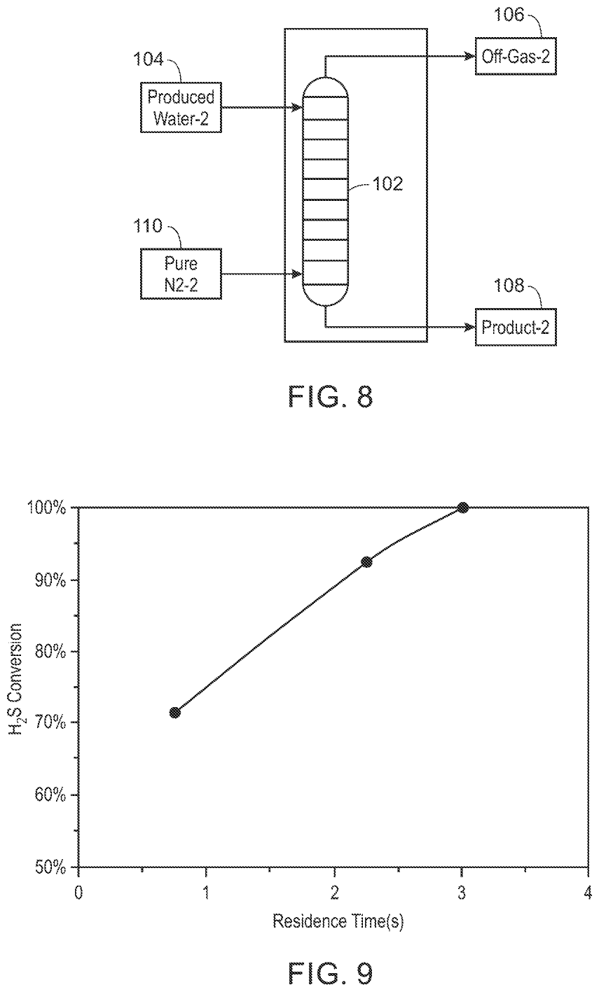

In the following, the process steps of the plasma-based H₂S decomposition are first described referring to FIG. 1. Various embodiments with a condenser, a second plasma reactor, an H₂ separator, or an ejector device, are described referring to FIGS. 2-6. FIG. 7 is an example process flow diagram. Simulation and experimental for H₂S stripping and plasma decomposition are then described referring to FIGS. 8-9 and Table 1. In this disclosure, unless otherwise noted, concentrations of gases components in a fluid are provided based on molar concentration in percentile, referred to as %.

H₂S Stripping from Produced Water

FIG. 1 is an example of a plasma-based system for H₂S decomposition. Solid arrows are used in FIG. 1 to indicate gas or liquid flows, e.g., inflow and outflow, possible during the plasma-based process.

In FIG. 1, a plasma-based system 100 includes an H₂S stripper 102, which is configured to receive produced water 104 from an oil/gas production facility and generate a H₂S-containing stripped gas stream (referred to as stripped gas). Accordingly, although not specifically illustrated in FIG. 1, the H₂S stripper 102 can be connected to an upstream system of the oil/gas production facility. In various embodiments, the produced water 104 is a by-product in oil and gas production. Since wellbore generally contain oil, water, and gas, water present in the wellbore is recovered as a by-product when oil is extracted from the oil wells. The water volume generated from the underground can be greater than the oil in some cases. Accordingly, the method of treating the produced water 104 can include a step of oil/water separation to isolate the produced water 104 for subsequent processing. Various materials in the wellbore such as brine and sulfur can be dissolved in the produced water 104. Accordingly, the produced water 104 contains salts and H₂S that need to be removed before reusing the water. The produced water 104 can also contain other components such as carbon dioxide (CO₂) and light hydrocarbons such as methane (CH₄). In some embodiments, the produced water 104 has a high salinity of at least 50,000 parts per million (ppm) total dissolved solids (TDS). In one or more embodiments, in addition to the water from oil wells, the produced water 104 also contains water added from an external source in the oil/gas production. For example, in hydraulic fracking, a pressurized liquid such as an aqueous solution containing additives such as proppants is injected into a wellbore for well stimulation. The mechanical and chemical stimulation in the wellbore induces cracking and mobilizing oil and gas in the formations.

In various embodiments, the H₂S stripper 102 includes an inlet 103 to receive the produced water 104, a first outlet 105 to output a stripped gas 106 and a second outlet 107 to output a residual solution 108. In some embodiments, the H₂S stripper 102 includes an optional gas inlet 109 to receive a purge gas 110 such as N₂.

The process of H₂S stripping includes, but not limited to, N₂ purging, pH changing via acid addition, thermal stripping and any combination of thereof. The gas purging involves purging or bubbling the produced water 104 with inert purge gas 110 such as N₂ to strip H₂S dissolved in the produced water 104. In some embodiments, an acid such as sulfuric acid can be used to lower the pH and thereby also lower the H₂S solubility to improve its removal. Heat can also be provided for better stripping. In some embodiments, instead of gas purging, a vacuum can be used to lower the pressure in the H₂S stripper 102 and the stripped gas 106 coming out of the H₂S stripper 102 may be free of purge gas 110. Accordingly, the H₂S stripper 102 can include a port connected to a vacuum pump with a pressure controller. In some embodiments, the vacuum can also be used in addition to the purge gas 110. In embodiments where N₂ purging is used, the concentration of H₂S in the stripped gas 106 can be controlled by the N₂ purge flow rate and it can be about a few ppm or greater, for example, from about 50 ppm to about 10%. In embodiments where vacuum stripping is used, it is possible to obtain the stripped gas 106 at a higher H₂S concentration, for example, about 90% or greater with pH control. In various embodiments, the stripped gas 106 contains H₂S and N₂. In some embodiments, the stripped gas 106 further contains trace amounts of other contaminants such as CO₂ and CH₄, where a trace amount is, for example, about 1% or less. It may also contain some residual sulfur species that was unreacted or not condensed after the plasma-based decomposition step. The stripped gas 106 can contain a water vapor and its concentration can depend on the process temperature and the amount of the purge gas. In some embodiments, the stripped gas 106 is saturated with the water vapor. In one embodiment, the stripped gas 106 contains 1-10% water vapor.

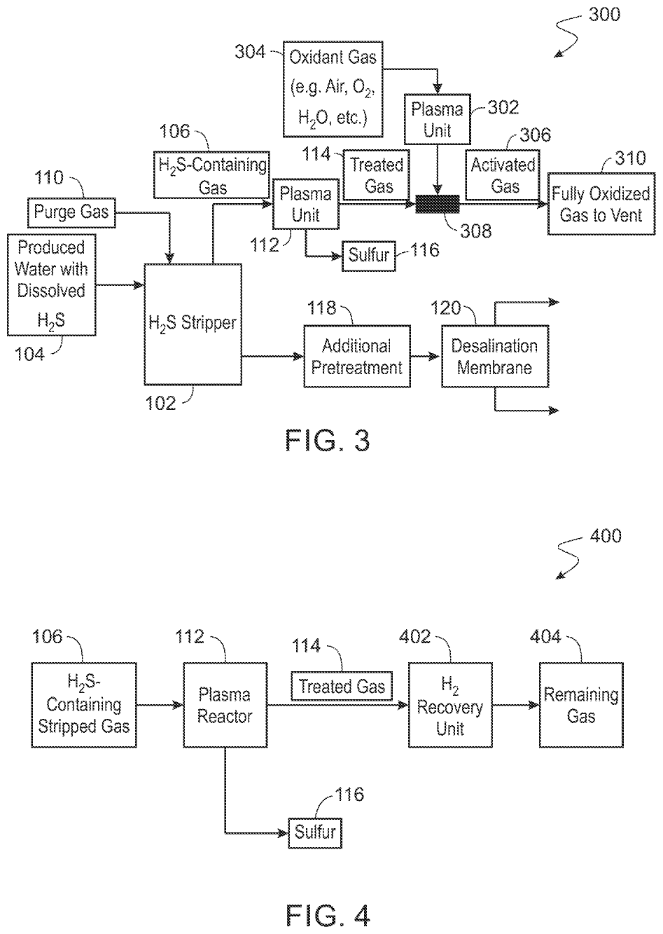

As further illustrated in FIG. 1, the plasma-based system 100 includes a first plasma reactor 112, which is configured to receive the stripped gas 106 from the H₂S stripper 102. In the first plasma reactor 112, a plasma can be ignited and H₂S of the stripped gas 106 can be decomposed to produce H₂ and elemental sulfur 116 (referred to as reaction 1, or R1 herein). In this disclosure, the plasma means an electrically charged gas containing electrons freed from the molecules and atoms in the gas and positively charged ions. The resulting gas including H₂ after the plasma-based H₂S decomposition is referred to as a treated gas 114 in this disclosure. Further, the ignition of a plasma in this disclosure means artificially generating a plasma by applying an electric and/or magnetic field to a gas to supply sufficient energy for discharging the gas, e.g., generating free electrons. The means of ignition can include but are not limited to arc discharge, corona discharge, dielectric barrier discharge, and microwave discharge. The treated gas 114 can be sent directly to flare as an exhaust gas (off-gas) as illustrated in FIG. 1. In some embodiments, the treated gas 114 can be further processed before released to atmosphere or used as a feed gas as described below referring to FIGS. 3-4.

H₂S→H₂+S (R1)

In various embodiments, the residual solution 108 coming out of the H₂S stripper 102 is treated for desalination. As further illustrated in FIG. 1, the plasma-based system 100 can include an additional pretreatment unit 118 connected to the H₂S stripper 102 and configured to perform one or more additional pretreatment of the residual solution 108. The additional pretreatments include but are not limited to removal of suspended solids, oil, dissolved oxygen, and grease, which can be achieved by filtration-based pretreatment, chemical-based filtration, or a combination thereof. For example, the additional pretreatment unit 118 includes a filtration unit having a filtration media such as nutshell filters, a chemical extraction unit that performs oxidation using suitable chemicals such as ozone, hydrogen, and peroxide, and other selective chemical extraction, or a combination thereof.

The plasma-based system 100 can further include a desalination membrane unit 120 downstream of the additional pretreatment unit 118 to remove the salts from the residual solution 108. Brine 122 obtained from the desalination can be treated as waste and the recovered water 124 can be sent to another facility for re-use. In some embodiments, the recovered water 124 can be used as injection water for hydraulic fracturing in oil and gas production. In one or more embodiments, the residual solution 108 can be reused directly without further purification.

FIG. 2 is an example of a condenser 202 connected to a first plasma reactor 112. Other components of the plasma-based system are already described above referring to FIG. 1 and thus omitted in FIG. 2 for illustration purposes. In some embodiments, the elemental sulfur 116 formed in the first plasma reactor 112 is condensed as a liquid (e.g., S₈) using the condenser 202 disposed downstream of the first plasma reactor 112. The produced sulfur is thus separated from the product gas stream. The remaining gas stream (e.g., the treated gas 114) can contain H₂, carbon monoxide (CO), and CO₂. In some embodiments, it also contains unreacted H₂S, depending on the plasma process conditions and the initial sulfur content in the stripped gas 106.

### Plasma-Based H₂S Decomposition

In various embodiments, the plasma for H₂S decomposition can be a dielectric barrier discharge (DBD), corona discharge, pulsed corona discharge, spark, glow, gliding arc, thermal arc, or microwave plasma. A wide range of operating pressure can be used depending on the type of plasma. For near-atmospheric pressure, dielectric barrier discharge (DBD), corona and pulse corona discharges, and microwave plasma can be used. The DBD can be selected for its applicability and versatility. The microwave plasma can be selected for its compact reactor size and the absence of need for electrodes. For high pressure operations such as 10 bar or greater, arc discharge can be used. Temperatures can be as low as room temperature, e.g., a non-thermal plasma, referred to as NTP herein, or thousands of degrees, e.g., a thermal plasma. Because thermal plasma is limited by a thermodynamic equilibrium, an extremely fast quenching is required for plasma process using thermal plasma to prevent recombination of sulfur and H₂.

On the other hand, NTP is a non-equilibrium process and can offer advantages in the plasma based H₂S decomposition. Although not wishing to be limited by any theory, NTP, even at relatively low temperatures, contains radicals and excited states of atoms and molecules that can exist at thermal equilibrium at much higher temperatures, e.g., greater than 1000° C. The non-equilibrium nature of NTP allows high H₂S conversion such as 90% or greater to take place at low temperatures such as less than 200° C. Accordingly, in some embodiments, a DBD plasma, an example NTP, is used. The DBD plasma can be generated applying between two electrodes, at least one of which is covered by a layer of dielectric material, a voltage higher than the breakdown voltage of the gas passing in between the two electrodes. The minimum voltage difference required to generate NTP depends on the gas composition, pressure, and the distance between the two electrodes. NTP can be operated at wide range of temperatures, for example, ranging from about 20° C. to about 900° C., and near atmospheric pressure such as about 1-5 bar. The unit “bar” as used herein refers to bar absolute (bara). In some embodiments, the first plasma reactor 112 is maintained during the plasma-based process at a temperature between about 150° C. and about 300° C. In some embodiments, the pressure may be about 100 kPa (about 1 bar) or lower. Although not wishing to be limited by any theory, the temperature range may be selected to optimize the balance between maximizing the H₂S decomposition rate and minimizing sulfur deposition on surfaces of the plasma chamber and/or catalysts used for the process. Further, performing the plasma-based process at less than about 100 kPa (about 1 bar) can enhance the H₂S plasma splitting efficiency. In some embodiments, the plasma is sustained with a voltage from about 1-50 kV with a frequency ranging from lower radio frequency (RF) to microwave frequencies.

In various embodiments, the plasma-based process H₂S decomposition may be performed using a catalyst to increase H₂S conversion and H₂ yield. Plasma can activate the catalyst(s) at low temperatures to increase the rate of reactions. A single catalyst, bifunctional catalyst, and/or physical mixture of different catalysts can be used. Examples of catalysts include but are not limited to metal sulfide, supported metal sulfide, metal nitrate, supported metal nitrides, zeolite, and carbon-based catalysts. In one or more embodiments, the catalyst includes molybdenum, cadmium, or zinc sulfides supported on alumina.

In some embodiments, the solid catalyst is placed fully or partially in the discharge zone of the first plasma reactor 112 such that the catalyst is also exposed to the plasma during the decomposition process. In alternate embodiments, the catalyst is placed downstream of the discharge zone and not directedly exposed to the plasma. In one or more embodiments, more than one catalyst is used, which can be placed both inside and outside the discharge zone.

In various embodiments, the process time for the plasma-based decomposition can be from about 0.1 s to about several hours depending on the plasma type and/or reactor geometry. In some embodiments, the first plasma reactor 112 can include a gas inlet to introduce a carrier or additive gas. In one or more embodiments, a noble gas such as He, Ne, Ar, Kr, and Xe, or N₂ may be introduced to the first plasma reactor 112.

In some embodiments, the first plasma reactor 112 is a catalytic DBD packed-bed reactor. Example designs of the DBD packed-bed reactor is described in U.S. patent publication No. 2023/0183588, which is incorporated herein by reference.

Although only one plasma reactor is illustrated in FIG. 1, it is possible to use more than one plasma reactor or a reactor with multiple plasma chambers, where the gas stream can be treated by different plasmas in series. Further, in some embodiments, the plasma-based process treats the stripped gas 106 with a plasma more than once with same or different plasma processing parameters, such as frequency, voltage, and residence time, among other.

### Secondary Plasma Reactor

FIG. 3 is an example of a plasma-based system 300 for H₂S decomposition including two plasma reactors: a first plasma reactor 112 and a second plasma reactor 302. Like numbered items are as described with respect to FIG. 1. In some embodiments, the treated gas 114 after the first plasma reactor 112 is sent to a second plasma treatment step for further purification. The second plasma treatment step can be an oxidation step, which may replace a conventional thermal oxidizer that oxidizes the treated gas 114.

First, in the second plasma reactor 302, a second plasma is ignited from an oxidant gas 304 including oxygen such as dioxygen (O₂), water (H₂O), and air flowed into the second plasma reactor 302. In the second plasma, various dissociations occur and activated oxidative species 306 can be generated (referred to as reactions 2-5, or R2-5 herein). In various embodiments, the second plasma can be a dielectric barrier discharge (DBD), corona discharge, pulsed corona discharge, spark, glow, gliding arc, thermal arc, or microwave plasma. The first and second plasmas can be ignited by the same discharge mechanism or different mechanisms.

Next, these activated oxidative species 306 can be injected to and mixed with the treated gas 114 in a mixing zone 308, where any remaining unreacted H₂S can be oxidized to form sulfur dioxide (SO₂) (referred to as reaction 6, or R6 herein) and/or gaseous sulfur can be oxidized (referred to as reaction 7, or R7 herein). In some embodiments, the mixing zone 308 is a part of the gas line downstream of the first plasma reactor 112 or another reactor chamber designated for the oxidation with temperature and pressure control capability. The oxidized treated gas can then be sent to flare as an exhaust gas 310. In some embodiments, H₂ in the treated gas 114 is completely oxidized to H₂O by this oxidation step. The use of secondary plasma reactor to perform the oxidation of the treated gas 114 immediately after the plasma-based decomposition step can be useful particularly when a flare is not available near the plasma-based system for produced water treatment.

In one or more embodiments, the plasma-based process can further include other steps before or after the second plasma step (oxidation). For example, the process includes multistage units, where multiple plasma catalytic units or non-plasma catalytic units are used in series to achieve the targeted sulfur removal and recovery. The generated SO₂ may be recovered instead of releasing as the exhaust gas by secondary sulfur recovery, for example, via Claus reaction. Accordingly, although not specially illustrated in FIG. 3, the plasma-based system can include other units for such further processing known to those in the skilled art.

O₂+e⁻→2O·+e⁻ (R2)

2O₂+e⁻→O₃+O·+e⁻ (R3)

H₂O+e⁻→H·+·OH+e⁻ (R4)

H₂O+O·→2·OH (R5)

$${H}_{2} S + \frac{3}{2} {O}_{2} \to {SO}_{2} + {H}_{2} O \qquad ( R6 )$$

S+O₂→SO₂ (R7)

### H₂ Separator

FIG. 4 is an example of an H₂ separator 402 connected to a first plasma reactor 112. Other components of the plasma-based system are already described above referring to FIG. 1 and thus omitted in FIG. 4 for illustration purposes. As illustrated in FIG. 4, H₂ of the treated gas 114 from the first plasma reactor 112 can be recovered. The H₂ separator 402 can be based on one or more H₂ separation techniques such as cryogenic distillation, pressure swing adsorption (PSA), and membrane separation. In some embodiments, more than one of these techniques are combined. The technology or process to recover H₂ from the treated gas 114 can be selected based on the H₂ concertation in the feed of the H₂ separator 402. Generally, the H₂ concentration in the treated gas 114 depends on the initial H₂S concentration in the stripped gas 106. Accordingly, the H₂ separator 402 can be installed for a process designed to treat the stripped gas 106 containing a high concentration of H₂S such as about 30% or greater, although the stripped gas 106 with other H₂ concentrations can also be treated for H₂ recovery. The recovered H₂ can be used for various applications, for example, generating electrical power to operate the first plasma reactor 112. In some embodiments, the second plasma reactor described above can be disposed downstream of the H₂ separator such that the remaining gas stream after H₂ recovery is further treated for oxidizing any residual sulfur species. The remaining gas 404 after the H₂ recovery can be released as an exhaust gas.

### Ejector Device

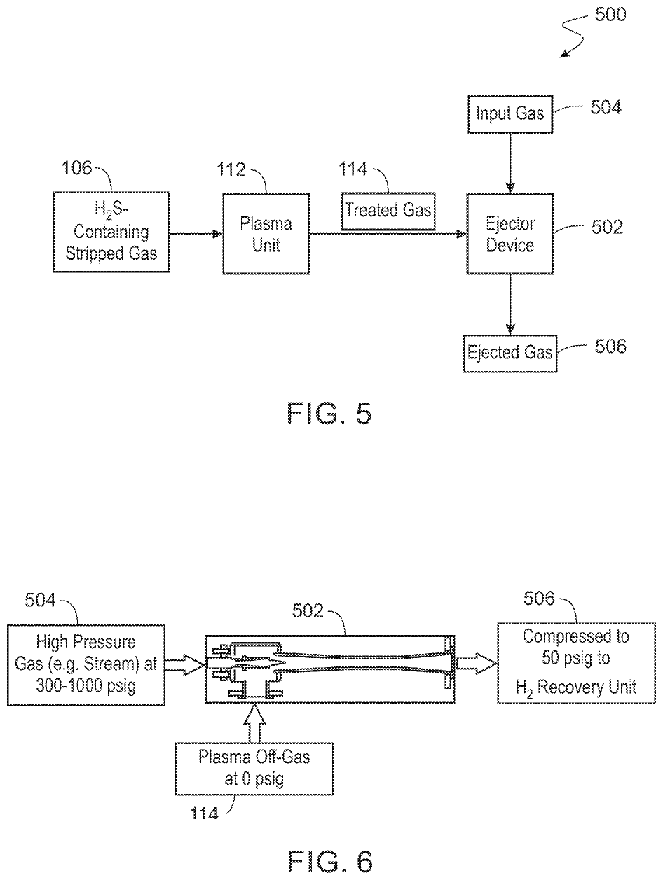

FIG. 5 is a block diagram of an ejector device 502 (vacuum ejector) connected to a first plasma reactor 112. FIG. 6 is a schematic drawing of the ejector device 502. In various embodiments, reducing the pressure in the first plasma reactor 112 can benefit the H₂S decomposition efficiency. The ejector device 502 can be positioned downstream of the first plasma reactor 112 and configured to create sub-atmospheric pressure, e.g., less than about 0 psig, in the first plasma reactor 112. In some embodiments, the pressure is maintained at less than about 1 atm (about 101.3 kPa) using the ejector device 502 for the duration of the plasma-based decomposition step. In the ejector device 502, low pressure is generated by flowing an input gas 504 such as a high-pressure stream from a gas inlet. For example, a high-pressure steam generated in a process facility can be used as the input gas 504. After passing the ejector device 502, the high-pressure steam can then be condensed and separated using, for example, a heat exchanger. In some embodiments, the pressure of the input gas 504 is between about 300 psig (about 2170 kPa) and about 1000 psig (about 6996 kPa). The input gas 504 is flowed through a nozzle to create vacuum and draw in the treated gas 114 from the first plasma reactor 112. The ejected gas 506 from the ejector device 502 can be compressed and sent to a subsequent process unit such as the H₂ separator 402 described referring to FIG. 4. In some embodiments, the ejected gas 506 is compressed to a pressure about 50 psig (about 446 kPa). The use of the ejector device 502 can allow the low-pressure plasma-based process as well as H₂S stripping without gas purging. Consequently, the ejector device 502 can enhance the overall H₂S plasma splitting efficiency, minimize/eliminate the need for N₂ purge, increase the concentration of striped H₂S and thus the produced H₂ which subsequently reduces the H₂ recovery cost.

### Process Flow Diagrams

FIG. 7 is a process flow diagram of a method 700 of H₂S decomposition in accordance with various embodiments. In FIG. 7, the method 700 starts with separating H₂S 702 from an aqueous solution, generating a gas stream including the H₂S. The gas stream is then flowed 704 into a plasma reactor, followed by igniting a plasma 706 in the plasma reactor including the gas stream. Subsequently, the H₂S is decomposed 708 to generate H₂ and elemental sulfur in the plasma generating a product gas stream including the H₂. The elemental sulfur is condensed 710 from the product gas stream as a liquid.

### Examples

The H₂S stripping from produced water 104 was simulated by Aspen HYSYS® to estimate the H₂S concentration in the stripped gas sent to the plasma reactor. FIG. 8 is a schematic diagram of H₂S stripping in an Aspen HYSYS® simulation. A produced water 104 of about 27 ft³/min that contains 100 ppm of H₂S was taken as an example. Table 1 summarizes the parameters and simulated H₂S recovery. The H₂S is stripped using N₂ flow of about 150 ft³/min as a purge gas 110, which resulted an off-gas stream as a stripped gas 106 that contains about 1.7% H₂S. The H₂S level in the residual solution 108 (liquid in Table 1) was negligible at less than 10-4 ppm.

TABLE 1
Aspen HYSYS ® simulation results for
H₂S stripping of produced water using N₂ purge.

| | Produced | | | |
|---|---|---|---|---|
| Stream | water | N₂ | Off-gas | Liquid |
| Temp. (° C.) | 40 | 40 | 39.99 | 39.81 |
| Press. (kPa) | 140.0 | 140.0 | 130.0 | 130.0 |
| Molar flow (kg-mole/h) | 2539 | — | 14.77 | 2538 |
| Actual vol. flow (ft³/min) | 27.03 | 150.0 | 173.9 | 27.01 |
| Total liq. Vol. flow | — | — | 12.03 | 1099.40 |
| (m³/d) | | | | |
| H₂S (ppm) | 100.0 | — | 1.719 × 10⁴ | 9.685 × 10⁻⁵ |

Further, lab scale experiments were also conducted to prove the capability of the plasma-based process to remove H₂S without any SOₓ emission. As an example based on the simulated H₂S concentration estimated by the Aspen HYSYS® simulation shown above, a feed gas containing 2% H₂S and 98% N₂ was introduced to a dielectric barrier discharge (DBD) plasma reactor operated at atmospheric pressure and 160° C. FIG. 9 shows the H₂S conversion as function of residence time. At residence time of about 3 seconds, complete removal of H₂S was achieved.

### Embodiments

An embodiment described herein provides a method of treating an aqueous solution, where the method includes separating H₂S from the aqueous solution, generating a gas stream including the H₂S, flowing the gas stream into a plasma reactor, igniting a plasma in the plasma reactor including the gas stream, decomposing the H₂S to generate H₂ and elemental sulfur in the plasma generating a product gas stream including the H₂, and condensing the elemental sulfur from the product gas stream as a liquid.

In an aspect, combinable with any other aspect, the method includes, prior to the separating, performing a crude oil/water separation generating the aqueous solution including the H₂S.

In an aspect, combinable with any other aspect, a residual solution after the separating includes salts, and the method further includes performing a desalination process of the residual solution using a membrane separator.

In an aspect, combinable with any other aspect, the separating includes purging N₂ to the aqueous solution.

In an aspect, combinable with any other aspect, the separating includes adding an acid to the aqueous solution, and placing the aqueous solution under a pressure less than 1 atm (101.3 kPa) using a vacuum.

In an aspect, combinable with any other aspect, the method further includes, after condensing the elemental sulfur, separating the H₂ from the product gas stream.

In an aspect, combinable with any other aspect, the product gas stream includes residual H₂S, and the method further includes oxidizing the residual H₂S in the product gas stream.

In an aspect, combinable with any other aspect, the oxidizing includes igniting another plasma including oxygen in another plasma reactor, generating an oxidative gas stream in the other plasma reactor, and mixing the oxidative gas stream with the product gas stream.

In an aspect, combinable with any other aspect, the method further includes maintaining a pressure during the decomposing in the plasma reactor at less than 1 atm (101.3 kPa) using an ejector device.

In an aspect, combinable with any other aspect, the plasma is a dielectric barrier discharge (DBD) plasma.

In an aspect, combinable with any other aspect, the plasma is a non-thermal plasma sustained at a temperature between 150° C. and 300° C.

An embodiment described herein provides a gas treatment system including an H₂S stripper to separate H₂S from an aqueous solution, where the H₂S stripper includes an inlet to receive the aqueous solution, a first outlet to output a gas stream including the H₂S, and a second outlet to output a residual solution, a first plasma reactor to receive the gas stream, where the first plasma unit is configured to sustain a first plasma of the gas stream in the first plasma reactor, where the H₂S is decomposed in the first plasma generating a product gas stream including H₂, and a condenser connected to and disposed downstream of the first plasma reactor.

In an aspect, combinable with any other aspect, the H₂S stripper includes a purge gas inlet.

In an aspect, combinable with any other aspect, the gas treatment system further includes a vacuum pump connected to the H₂S stripper.

In an aspect, combinable with any other aspect, the gas treatment system further includes: a pretreatment unit connected to the second outlet and configured to treat the residual solution; and a desalination membrane connected to and disposed downstream of the pretreatment unit.

In an aspect, combinable with any other aspect, the gas treatment system further includes a second plasma reactor connected to a mixing zone downstream of the first plasma reactor, where the second plasma reactor is configured to sustain a second plasma including oxygen generating an oxidative gas, where the oxidative gas is mixed with the product gas stream in the mixing zone.

In an aspect, combinable with any other aspect, the gas treatment system further includes an ejector device connected to and disposed downstream of the first plasma reactor to maintain a pressure less than 1 atm (101.3 kPa) in the first plasma reactor, where the ejector device includes a first gas inlet, a second gas inlet, and a gas outlet, where the second gas inlet is connected to the first plasma reactor.

In an aspect, combinable with any other aspect, the first plasma reactor is charged with a catalyst including metal sulfide, supported metal sulfide, metal nitrate, supported metal nitride, a zeolite, or a carbon-based catalyst.

An embodiment described herein provides a gas treatment system including an H₂S stripper to separate H₂S from an aqueous solution, where the H₂S stripper includes an inlet to receive the aqueous solution, a first outlet to output a gas stream including the H₂S, and a second outlet to output a residual solution, a first plasma reactor to receive the gas stream, the first plasma reactor configured to sustain a first plasma of the gas stream in the first plasma reactor, where the H₂S is decomposed in the first plasma generating a product gas stream including H₂, a condenser connected to and disposed downstream of the first plasma reactor, and an H₂ separator connected to and disposed downstream of the condenser.

In an aspect, combinable with any other aspect, the H₂ separator includes a cryogenic distillation unit, a pressure swing adsorption (PSA) unit, or a membrane separator.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of treating an aqueous solution, the method comprising:
separating H₂S from the aqueous solution, generating a gas stream comprising the H₂S;
flowing the gas stream into a plasma reactor;
igniting a plasma in the plasma reactor comprising the gas stream;
decomposing the H₂S to generate H₂ and elemental sulfur in the plasma generating a product gas stream comprising the H₂; and
condensing the elemental sulfur from the product gas stream as a liquid.

2. The method of claim 1, further comprising, prior to the separating, performing a crude oil/water separation generating the aqueous solution comprising the H₂S.

3. The method of claim 1, wherein a residual solution after the separating comprises salts, the method further comprising performing a desalination process of the residual solution using a membrane separator.

4. The method of claim 1, wherein the separating comprises purging N₂ to the aqueous solution.

5. The method of claim 1, wherein the separating comprises:
adding an acid to the aqueous solution; and
placing the aqueous solution under a pressure less than 1 atm (101.3 kPa) using a vacuum.

6. The method of claim 1, further comprising, after condensing the elemental sulfur, separating the H₂ from the product gas stream.

7. The method of claim 1, wherein the product gas stream comprises residual H₂S, the method further comprising oxidizing the residual H₂S in the product gas stream.

8. The method of claim 7, wherein the oxidizing comprises:
igniting another plasma comprising oxygen in another plasma reactor, generating an oxidative gas stream in the another plasma reactor; and
mixing the oxidative gas stream with the product gas stream.

9. The method of claim 1, further comprising maintaining a pressure during the decomposing in the plasma reactor at less than 1 atm (101.3 kPa) using an ejector device.

10. The method of claim 1, wherein the plasma is a dielectric barrier discharge (DBD) plasma.

11. The method of claim 1, wherein the plasma is a non-thermal plasma sustained at a temperature between 150° C. and 300° C.

12. A gas treatment system comprising:
an H₂S stripper to separate H₂S from an aqueous solution, the H₂S stripper comprising
an inlet to receive the aqueous solution,
a first outlet to output a gas stream comprising the H₂S, and
a second outlet to output a residual solution;
a first plasma reactor to receive the gas stream, the first plasma unit configured to sustain a first plasma of the gas stream in the first plasma reactor, wherein the H₂S is decomposed in the first plasma generating a product gas stream comprising H₂; and
a condenser connected to and disposed downstream of the first plasma reactor.

13. The gas treatment system of claim 12, wherein the H₂S stripper comprises a purge gas inlet.

14. The gas treatment system of claim 12, further comprising a vacuum pump connected to the H₂S stripper.

15. The gas treatment system of claim 12, further comprising:
a pretreatment unit connected to the second outlet and configured to treat the residual solution; and
a desalination membrane connected to and disposed downstream of the pretreatment unit.

16. The gas treatment system of claim 12, further comprising a second plasma reactor connected to a mixing zone downstream of the first plasma reactor, the second plasma reactor configured to sustain a second plasma comprising oxygen generating an oxidative gas, wherein the oxidative gas is mixed with the product gas stream in the mixing zone.

17. The gas treatment system of claim 12, further comprising an ejector device connected to and disposed downstream of the first plasma reactor to maintain a pressure less than 1 atm (101.3 kPa) in the first plasma reactor, the ejector device comprising a first gas inlet, a second gas inlet, and a gas outlet, the second gas inlet connected to the first plasma reactor.

18. The gas treatment system of claim 12, wherein the first plasma reactor is charged with a catalyst comprising metal sulfide, supported metal sulfide, metal nitrate, supported metal nitride, a zeolite, or a carbon-based catalyst.

19. A gas treatment system comprising:
an H₂S stripper to separate H₂S from an aqueous solution, the H₂S stripper comprising
an inlet to receive the aqueous solution,
a first outlet to output a gas stream comprising the H₂S, and
a second outlet to output a residual solution;
a first plasma reactor to receive the gas stream, the first plasma reactor configured to sustain a first plasma of the gas stream in the first plasma reactor, wherein the H₂S is decomposed in the first plasma generating a product gas stream comprising H₂;
a condenser connected to and disposed downstream of the first plasma reactor; and
an H₂ separator connected to and disposed downstream of the condenser.

20. The gas treatment system of claim 19, wherein the H₂ separator comprises a cryogenic distillation unit, a pressure swing adsorption (PSA) unit, or a membrane separator.
